(19) United States
(12) Patent Application Publication
(10) Pub. No.: US 2026/0108949 A1
(43) Pub. Date: Apr. 23, 2026

(54) DEVICE FOR CONTROLLING SPATIAL ELECTRIC FIELD FOR 3D PRINTING

(71) Applicant: ShanghaiTech University, Shanghai (CN)

(72) Inventors: Jicheng FENG, Shanghai (CN); Shirong LIU, Shanghai (CN)

(73) Assignee: ShanghaiTech University, Shanghai (CN)

(21) Appl. No.: 18/994,072

(22) PCT Filed: Sep. 2, 2022
(86) PCT No.: PCT/CN2022/116705

§ 371 Date: Jan. 14, 2025

(30) Foreign Application Priority Data
Aug. 25, 2022 (CN) 2022110280198

(51) Int. Cl. B22F 12/90; B22F 1/14; B33Y 30/00; B33Y 40/10

(52) U.S. Cl. CPC B22F 12/90; B22F 1/14; B33Y 30/00; B33Y 40/10

(57) ABSTRACT

A device for controlling a spatial electric field for desirable 3D printing is provided. By sequentially arranging a top electrode plate, a configurable number of intermediate electrode plates with perforations, and a bottom electrode plate, and altering their configurable potential, relative position, and the size, number, shape, and distribution of perforations on the plates, a focused electric field required for printing is constructed. This focused electric field can then focus, disperse, screen, and separate the charged substances within it. Furthermore, by adjusting the potentials of the plates, plate positions, and the perforation distribution on the plates, the strength and the shape of electric field lines for the spatial electric field can be modified, enabling control over the feature sizes and printing locations of the 3D nanoarchitectures, offering high flexibility, simplicity, and strong controllability. In addition, the presently disclosed device can be applied across various scales.

### FIELD OF THE INVENTION

The present disclosure relates to the field of 3D printing, and in particular, to a device for controlling a spatial electric field for 3D printing.

### BACKGROUND OF THE INVENTION

3D printing technology, emerging as a high-end manufacturing technique in the new century, enables the creation of parts of any shape directly from computer graphic data without mechanical processing or molds, which greatly shortens the product development cycle, enhances productivity, and reduces production costs. Moreover, compared to traditional technology, 3D printing eliminates the need for production lines, thereby significantly reducing costs and material waste. 3D printing technology also allows for the production of shapes that traditional manufacturing techniques cannot achieve.

Common 3D printing technologies include Stereolithography (SLA), Fused Deposition Modeling (FDM), Three-Dimensional Printing (3DP), Selective Laser Sintering (SLS), and Inkjet Printing (PolyJet). These mainstream technologies typically use nozzles and laser sintering to achieve pixel stacking of 3D printed objects. However, these methods impose stringent requirements on materials, such as viscosity, melting point, and phase separation characteristics. As a result, the diversity of 3D printing materials, especially metals and alloys, is greatly limited. Currently, 3D technology cannot achieve cross-scale printing of multiple metal materials, particularly in the micro-nano 3D printing field. Consequently, commercially available micro-nano scale metal 3D printers are almost nonexistent.

Addressing these limitations, recently emerging electric field control 3D printing technology is gaining traction. By utilizing methods like electrophoresis and electrostatic jetting, this technology pulls charged substances from the nozzle to assemble 3D structures on the substrate, enabling micro-nano 3D printing of some metal materials. Nonetheless, due to nozzle limitations, it still imposes significant restrictions on material and size. However, a recent advancement in 3D printing technology has introduced the use of electric fields to create virtual printing nozzles, directly addressing these limitations. This method achieves the convergence of electric field lines using charges loaded on the surface of insulating materials, allowing the printing of charged substances. Although this method can produce simple structures, it suffers from poor controllability. The adjustment of printing size relies on the self-regulating mechanism of surface charges (charge replenishment and natural loss), which limits the range of adjustable printing sizes. This method is only suitable for the micro-nano field and also faces issues like surface contamination that can damage the print.

### SUMMARY OF THE INVENTION

In view of the above-mentioned shortcomings, the present disclosure provides a device for controlling a spatial electric field for 3D printing.

This device comprises a top electrode plate, a configurable number of intermediate electrode plates, and a bottom electrode plate disposed in sequence. Each of the intermediate electrode plates is provided with a configurable number of perforations for electric field lines to pass through, so as to form motion channels of charged substances. Each of the top electrode plate, the intermediate electrode plates, and the bottom electrode plate has a configurable potential applied thereto. Shapes of a particle beam formed by the charged substances are controlled by one or more of adjusting methods comprising adjusting relative positions of the intermediate electrode plates with respect to the top and bottom electrode plates, changing the potentials applied to the electrode plates, and varying positions of the perforations on the intermediate electrode plates. The spatial electric field is constructed such that the charged substances migrate to a specific position on the bottom electrode plate, controlling feature sizes and printing locations of 3D nanoarchitectures.

In an embodiment of the present disclosure, one or more adjustments comprising a convergence state adjustment, a dispersion state adjustment, a screening state adjustment, a separation state adjustment, a signal strength change adjustment, and a motion path adjustment are performed on the charged substances by one or more of the adjusting methods.

In an embodiment of the present disclosure, a motion path of the charged substances is adjusted by adjusting the relative positions of the intermediate electrode plates with respect to the top and bottom electrode plates. The relative positions comprise relative angular positions and distances between the electrode plates. A bending state of the particle beam is adjusted by adjusting the relative angular positions, and dimensions of the particle beam are adjusted by adjusting the distance between the electrode plates.

In an embodiment of the present disclosure, the shapes, direction, dimensions, and strength of the particle beam are adjusted by adjusting the potentials applied to the electrode plates, such that one or more of the adjusting methods are performed on the charged substances.

In an embodiment of the present disclosure, the potentials applied to the electrode plates are configured to toggle between different modes comprising: a first mode where a convergent electric field is formed to focus the charged substances; a second mode where a dispersing electric field is formed to disperse the charged substances; a third mode where a particle screening electric field is formed to screen the charged substances; a fourth mode where a separating electric field is formed to separate the charged substances; and a fifth mode where the charged substances generate a specific signal detectable by a corresponding sensor.

In an embodiment of the present disclosure, the charged substances comprise one or more of particles ranging from atomic to microns in size, or other particles like electrons, protons, and ions, and the charged substances are formed by metals, alloys, or semiconductors, or some insulating materials, each of which is charged.

In an embodiment of the present disclosure, a distribution of the spatial electric field is adjusted by adjusting the number and/or shape of the intermediate electrode plates, and the charged substances are controlled to move along the electric field lines having a preset shape.

In an embodiment of the present disclosure, dimensions and shapes of the particle beam are controlled by adjusting one or more of aperture sizes, the number of the perforations, the positions of the perforations, and shapes of the perforations on the intermediate electrode plates, so as to control a directional migration of the particle beam.

In an embodiment of the present disclosure, a single-point printing controlled by the spatial electric field is performed when each of the intermediate electrode plates is configured with one accessible perforation, and a multi-point synchronous printing controlled by the spatial electric field is performed when each of the intermediate electrode plates is configured with a plurality of accessible perforations.

In an embodiment of the present disclosure, dielectrics among the electrode plates are liquids or gases, or space among the electrode plates that is in a vacuum state.

As described above, the present disclosed device for controlling the spatial electric field for 3D printing has several beneficial effects. First, by sequentially arranging the top electrode plate, the configurable number of intermediate electrode plates with perforations, and the bottom electrode plate, and altering their configurable potential, relative position, and the size, number, shape, and distribution of the perforations on the plates, a focused electric field required for printing is constructed. This focused electric field can then focus, disperse, screen, and separate charged substances (or, CS) within it. Furthermore, by adjusting the potentials of the plates, plate positions, and the perforation distribution on the plates, the strength and the shape of the electric field lines for the spatial electric field can be modified, enabling control over the feature sizes and printing locations of the 3D nanoarchitectures, offering high flexibility, simplicity, and strong controllability. In addition, the present disclosed device can be applied across various scales. Depending on the scale of the corresponding device, the present disclosed device can 3D print structures ranging from centimeters to nanometers. Moreover, the presently disclosed device is versatile and can be utilized in fields such as micro-nano processing, separation engineering, and signal processing, thereby achieving functions like beam converging, signal modulation, dispersion, or screening.

### BRIEF DESCRIPTION OF DRAWINGS

FIG. 1 is a schematic structural diagram of a device for controlling a spatial electric field for 3D printing according to an embodiment of the present disclosure.

FIG. 2 is a schematic diagram of one type of electric fields constructed by the device for controlling the spatial electric field for 3D printing according to an embodiment of the present disclosure.

FIG. 3 is a schematic diagram of another type of electric fields constructed by the device for controlling the spatial electric field for 3D printing according to an embodiment of the present disclosure.

FIG. 4 is a perspective structural diagram of the device for controlling the spatial electric field for 3D printing according to an embodiment of the present disclosure.

FIG. 5 is a schematic cross-sectional view of the device for controlling the spatial electric field for 3D printing according to an embodiment of the present disclosure.

FIG. 6 is a schematic diagram of yet another type of the electric field constructed by the device for controlling the spatial electric field for 3D printing according to an embodiment of the present disclosure.

FIG. 7 is a perspective structural diagram of a device for controlling a spatial electric field for arrayed 3D printing according to an embodiment of the present disclosure.

FIG. 8 is a schematic cross-sectional view of the device for controlling the spatial electric field for arrayed 3D printing according to an embodiment of the present disclosure.

FIG. 9 is a perspective structural diagram of a device for controlling the spatial electric field for 3D printing according to another embodiment of the present disclosure.

FIG. 10 shows an SEM image of an arrayed 3D nanostructure prepared by a 3D printing prototype with a structure shown in FIG. 9.

FIG. 11 is a perspective structural diagram of a device for controlling the spatial electric field for 3D printing according to yet another embodiment of the present disclosure, which utilizes plate potentials to control the spatial electric field for particle screening.

FIG. 12 is a schematic cross-sectional view of the device for controlling the spatial electric field for 3D printing shown in FIG. 11.

FIG. 13 is a diagram showing a screening result of charged nanoparticles by the device for controlling the spatial electric field for 3D printing according to an embodiment of the present disclosure.

FIG. 14 is a diagram showing another screening result of charged nanoparticles by the device for controlling the spatial electric field for 3D printing according to an embodiment of the present disclosure.

### DETAILED DESCRIPTION OF THE INVENTION

The embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It should be noted that the following embodiments and the features of the following embodiments can be combined with each other if no conflict will result.

In the following description, the drawings describe several embodiments of the present disclosure. It should be understood that other embodiments can also be used to implement the present disclosure, and changes in mechanical composition, structure, electricity and operation can be made without departing from the spirit and scope of the present disclosure. The following detailed description should not be considered as restrictive. The terms used herein are only intended to describe specific embodiments and are not intended to restrict the present disclosure. Spatial terms, such as “up”, “down”, “left”, “right”, “below”, “under”, “beneath”, “above”, “over”, etc., can be used herein to facilitate the description of the relationship between one element or feature and another element or feature shown in the figures.

Throughout the specification, when a component is “connected” with another component, this includes not only the “direct connection” but also the “indirect connection” in which other elements are placed therebetween. In addition, when a certain component “includes” or “comprises” a certain element, unless otherwise stated, other elements are not excluded, which means other elements may be included.

The terms “first,” “second,” “third,” and the like, are intended to denote various elements, components, regions, layers, and/or sections. These terms are merely employed to distinguish one element, component, region, layer, or section from another. Consequently, a feature described as a “first” element, component, region, layer, or section could, within the scope of the present disclosure, be referred to as a “second” element, component, region, layer, or section.

As used herein, the singular forms “a”, “an” and “said/the” are intended to include the plural forms, unless the context clearly points out differently. It should be further understood that the terms “include” and “comprise” indicate the existence of the described features, steps, operations, elements, components, items, categories, and/or groups, but do not exclude the existence, presence, or addition of one or more other features, steps, operations, elements, components, items, categories, and/or groups. As used herein, the terms “or” and “and/or” are inclusive, and are used to include any of the associated listed items and all combinations thereof. Thus, “A, B or C” or “A, B and/or C” means “any of the following: A; B; C; A and B; A and C; B and C; A, B and C. Exceptions to this definition apply only when combinations of elements, functions or operations are inherently paradoxical in some way.

The present disclosure provides a device for controlling a spatial electric field for 3D printing, and by sequentially arranging a top electrode plate, a configurable number of intermediate electrode plates with perforations, and a bottom electrode plate, and altering their configurable potential, relative position, and the size, number, shape, and distribution of perforations on the plates, a focused electric field required for printing is constructed. This focused electric field can then focus, disperse, screen, and separate the charged substances within it. Furthermore, by adjusting the potentials of the plates, plate positions, and the perforation distribution on the plates, the strength and the shape of electric field lines for the spatial electric field can be modified, enabling control over the feature sizes and printing locations of 3D nanoarchitectures, offering high flexibility, simplicity, and strong controllability. In addition, the present disclosed device can be applied across various scales. Depending on the scale of the corresponding device, the present disclosed device can 3D print structures ranging from centimeters to nanometers. Moreover, the present disclosed device is versatile and can be utilized in fields such as micro-nano processing, separation engineering, and signal processing, thereby achieving functions like beam converging, signal modulation, dispersion, or screening.

The following detailed description is provided for embodiments of the present disclosure with reference to the accompanying drawings so that they can be easily implemented by a person skilled in the art to which the present disclosure belongs. The present disclosure can be embodied in a variety of different forms and is not limited to the embodiments described herein.

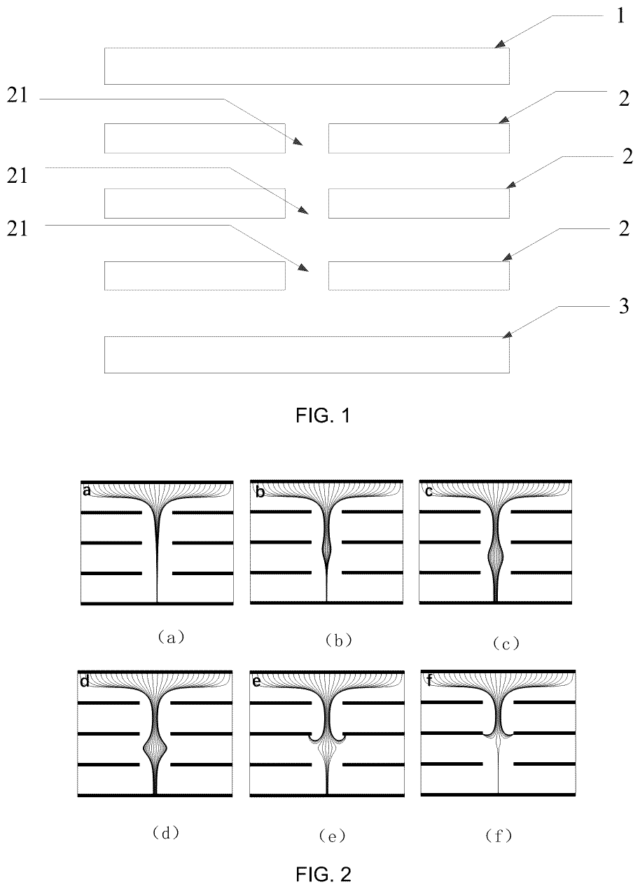

FIG. 1 is a schematic structural diagram of a device for controlling a spatial electric field for 3D printing according to an embodiment of the present disclosure.

The present disclosed device comprises a top electrode plate 1, a configurable number of intermediate electrode plates 2 (with three plates shown in FIG. 1 as an example), and a bottom electrode plate 3 disposed in sequence. The intermediate electrode plates 2 are disposed between the top electrode plate 1 and the bottom electrode plate 3. Each of the intermediate electrode plates 2 is provided with a configurable number of perforations 21 (with one perforation shown in FIG. 1 as an example) for electric field lines to pass through, so as to form motion channels of charged substances. Diameters of the motion channels are smaller than those of the perforations 21. Furthermore, the top electrode plate 1, the intermediate electrode plates 2, and the bottom electrode plate 3 are all powered electrode plates, each having a configurable potential applied thereto. Notably, the top electrode plate 1 and the bottom electrode plate 3 are not restricted to vertical placement but can also be positioned horizontally.

Shapes (or, motion) of a particle beam formed by the charged substances are controlled by one or more of adjusting methods comprising adjusting relative positions of the intermediate electrode plates with respect to the top and bottom electrode plates, changing the potentials applied to the electrode plates, and varying positions of the perforations on the intermediate electrode plates. The spatial electric field is constructed such that the charged substances migrate to a specific position on the bottom electrode plate, controlling feature sizes and printing locations of the 3D nanoarchitectures.

In one embodiment, the size and drop locations of the particle beam can be fine-tuned by altering the adjusting methods. Additionally, one or more adjustments comprising a convergence state adjustment, a dispersion state adjustment, a screening state adjustment, a separation state adjustment, a signal strength change adjustment, and a motion path adjustment are performed on the charged substances by one or more of the adjusting methods, thereby allowing for functionalities such as convergence, dispersion, screening, separation, and path adjustment of the charged substances. These functions can be switched and adjusted with high flexibility and operability simply by modifying the potentials of the electrode plates, plate positions, and the perforation distribution on the electrode plates.

In one embodiment, the charged substances comprise one or more of particles ranging from atomic to microns in size, or other particles like electrons, protons, and ions, and the charged substances are formed by metals, alloys, or semiconductors, or some insulating materials, each of which is charged.

To better illustrate how to control the motion of charged substances, the following describes the specific process of adjusting the applied potential of each electrode plate to control the deformation of the spatial electric field, which in turn, directs the charged substances to migrate to the specific position.

By adjusting the potential applied to each electrode plate, the shape, direction, size, and intensity of the particle beam can be adjusted, allowing for one or more adjustments comprising the convergence state adjustment, the dispersion state adjustment, the screening state adjustment, the separation state adjustment, the signal strength change adjustment, and the motion path adjustment to be performed on the charged substances.

It is important to note that under unchanged conditions, the above adjustments can be performed solely by altering the potential applied to each electrode plate. Additionally, these adjustments can be combined with changes in other conditions to achieve similar effects.

For example, other conditions may comprise the relative positions of the intermediate electrode plates with respect to the top and bottom electrode plates, the number and shape of the electrode plates, and the number, size, position, and shape of the perforations on the electrode plates.

In a specific embodiment, the potentials applied to the electrode plates create different potential relationships. Specifically, the potentials applied to the electrode plates are configured to toggle between different modes (or, different potential relationships) comprising: a first mode where a convergent electric field is formed to focus the charged substances; a second mode where a dispersing electric field is formed to disperse the charged substances; a third mode where a particle screening electric field is formed to screen the charged substances; a fourth mode where a separating electric field is formed to separate the charged substances; and a fifth mode where the charged substances generate a specific signal detectable by a corresponding sensor. For example, as shown in portion a of FIG. 2, adjusting the potentials of five powered electrode plates can produce various electric fields with different functions. The intermediate three are intermediate electrode plates, providing motion channels of the charged substances. Incrementally increasing or decreasing the potentials of these intermediate electrode plates can achieve multi-level convergence or dispersion of the charged substances. The convergent electric field, the dispersing electric field, and the potentials applied to the electrode plates are related to the required intensity for each function.

When the potentials applied to the intermediate electrode plates are adjusted to form the dispersing electric field, the charged substances can be effectively dispersed. For example, as shown in portions b, c, and d of FIG. 2, adjusting the potentials of the intermediate electrode plates can make the particle beam of the charged substances to have an expanded region below one of the intermediate electrode plates. This expanded region can rearrange and separate the charged substances based on their properties, leading to a specific distribution of the charged substances on the bottom electrode plate. The separating electric field and the potentials applied to the electrode plates are related to the characteristics of the charged particles being separated.

When the potentials applied to the intermediate electrode plates are adjusted to form the particle screening electric field, the charged substances can be screened. For example, as shown in portions e and f of FIG. 2, adjusting the potentials of the intermediate electrode plates can cause part of the electric field lines to land on the intermediate electrode plates, thus achieving particle screening. The particle screening electric field and the potentials applied to the electrode plates are related to the properties of the particles that need to be screened.

When the potentials applied to the intermediate electrode plates are adjusted to create a potential relationship that corresponds to signal changes, the charged substances can generate the specific signal, which can then be detected by the corresponding sensor. For example, by adjusting the potentials, the number of the charged substances reaching signal-receiving sensors is controlled, enhancing or weakening the signal.

The above potential relationships can be obtained through electrostatic field calculations, providing precise theoretical models for guidance. In other words, magnitudes of the potentials applied to the electrode plates corresponding to different potential relationships can be calculated based on calculations of electrostatic field potentials based on specific conditions. These conditions comprise the required electric field intensity, the distance between the electrode plates, the thickness of the electrode plates, and other factors.

In a specific embodiment, the magnitudes of the potentials applied to the electrode plates corresponding to different potential relationships are determined using Gauss's law for electric flux, given by formula (1):

$${∮}_{s} \vec{E} \cdot d \vec{S} = \frac{Q}{{ε}_{0}} . \qquad Formula ( 1 )$$

Based on formula (1), the relationship between the sizes of the particle beams between each pair of adjacent electrode plates in multi-plate control can be further determined as follows:

$$\frac{{V}_{1} - {V}_{2}}{{h}_{12}} {R}_{12}^{2} = \frac{{V}_{3} - {V}_{2}}{{h}_{23}} {R}_{23}^{2} = … = \frac{{V}_{n} - {V}_{n - 1}}{{h}_{n ( n - 1 )}} {R}_{n ( n - 1 )}^{2} . \qquad Formula ( 2 )$$

Here, V₁, V₂ . . . . Vₙ represent the potentials on each parallel electrode plate; h₁₂, h₂₃ . . . hₙ₍ₙ₋₁₎ represent the distances between the electrode plates; and R₁₂, R₂₃ . . . . Rₙ₍ₙ₋₁₎ represent the average radius of the particle beams between the electrode plates.

Specifically, from the above formula, it can be calculated that when the number of the intermediate electrode plates is three, the radius of the particle beam formed by the focused charged substances is:

$${R}_{h} = \sqrt{\frac{{R}_{g}^{2} {h}_{b} ( {V}_{t} - {V}_{m} )}{{h}_{t} ( {V}_{m} - {V}_{b} )}} . \qquad Formula ( 3 )$$

Here, Rₕ is the radius of the particle beam reaching the bottom electrode plate, R_{g} is a parameter related to aperture sizes of the intermediate electrode plates, Vt, Vₘ . . . V_{b} are the potentials of the top, intermediate, and bottom electrode plates, respectively, and h_{b} and hₜ are the distances between the top and intermediate plates and the intermediate and bottom plates, respectively. In one embodiment, the separation of the charged substances includes separating one or more types of charged substances based on different mass, density, electric displacement, charge, and electric polarity. Specifically, by setting a rearrangement mechanism based on these properties, the corresponding charged substances can be effectively separated.

To better illustrate how to control the motion of the charged substances, the following describes the process of changing the relative positions of the top electrode plate, the intermediate electrode plates, and the bottom electrode plate.

By adjusting these relative positions, the motion path of the charged substances can be controlled.

It is important to note that the motion path of the charged substances can be adjusted solely by altering the relative positions. Additionally, the adjustment of the motion path can also be combined with changes in other conditions to achieve the desired motion path.

For example, the other conditions here may comprise the potentials applied to the electrode plates, the number and shape of the electrode plates, and the number and shape of the perforations in the electrode plates.

In a specific embodiment, the relative positions refer to the angular positions and the distances between the electrode plates.

As shown in FIG. 2, under unchanged conditions, the bending state of the particle beam can be adjusted by altering the angular positions between the electrode plates. The greater the angle, the greater the bending. Similarly, by adjusting the distance between the electrode plates, the size of the particle beam can be adjusted, thus altering the electric field intensity of the particle beam. The larger the distance, the longer the extension life of the particle beam.

To better illustrate how to control the motion of the charged substances, the following describes the process of changing the number and shape of the intermediate electrode plates to control the motion of the charged substances.

By adjusting the number and shape of the intermediate electrode plates, the motion of the charged substances can be controlled.

It is important to note that under the motion path of the charged substances can be adjusted solely by altering the number and/or shape of the intermediate electrode plates. Additionally, the adjustment of the motion path can be combined with changes in other conditions to achieve the desired motion path.

For example, the other conditions (other than the number of the electrode plates) may comprise the relative positions, the potentials applied to the electrode plates, the shape of the electrode plates, and the number, position, and shape of the perforations in the electrode plates. Similarly, the other conditions (other than the shape of the electrode plates) may comprise the relative positions, the potentials applied to the electrode plates, the number of the electrode plates, and the number, position, and shape of the perforations in the electrode plates.

As shown in FIG. 2, the motion path and the shape of the particle beam can be adjusted by increasing the number of intermediate electrode plates. More plates allow for more adjustable positions. It is important to note that the additional intermediate electrode plates can have either the same or different perforation patterns.

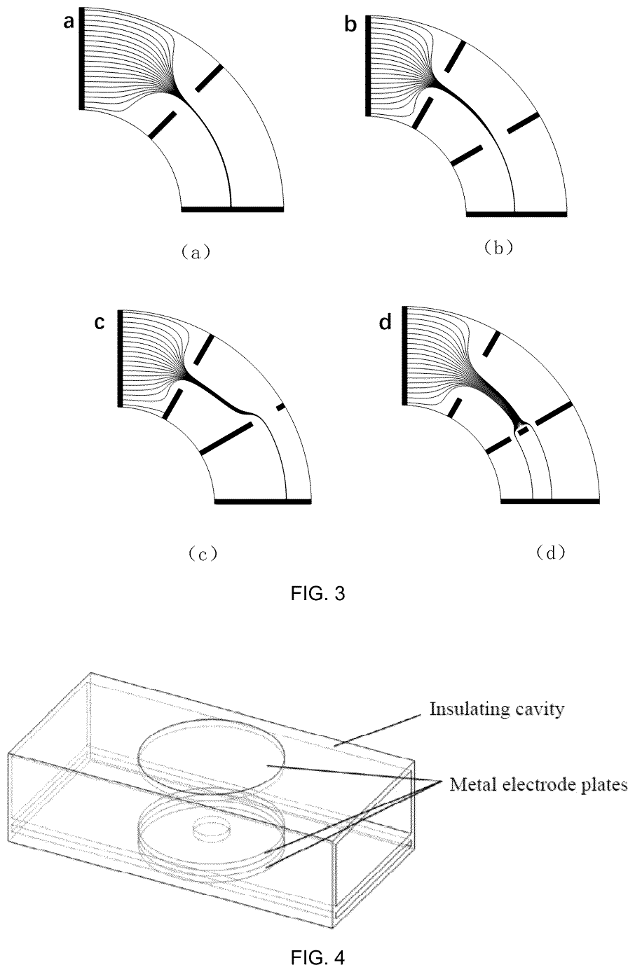

As shown in FIG. 3, the motion path and the shape of the particle beam can be adjusted by changing the shapes of the intermediate electrode plates. For example, the intermediate electrode plates can be a concave plate to produce a converging beam of charged substances, or a convex plate to produce a dispersing beam. The shapes of the intermediate electrode plates can be rectangular, spherical, ellipsoidal, or various irregular 3D shapes.

To better illustrate how to control the motion of the charged substances, the following describes the process of changing the number, position, and shape of the perforations in the intermediate electrode plates.

By adjusting the aperture size, number, position, and shape of the perforations in the intermediate electrode plates, the size of the particle beam and the density and shape of the focused electric field lines can be controlled, thereby directing the motion of the particle beam.

It is important to note that under unchanged conditions, the motion path of the charged substances can be adjusted solely by altering the aperture size, number, position, and shape of the perforations. Additionally, the adjustment of the motion path can be combined with changes in other conditions to achieve the desired motion path.

For example, the other conditions (other than the aperture size of the perforations) may comprise the relative positions, the potentials applied to the electrode plates, the number and shape of the electrode plates, and the number, position, and shape of the perforations in the electrode plates. Similarly, the other conditions (other than the number of the perforations) may comprise the relative positions, the potentials applied to the electrode plates, the number and shape of the electrode plates, and the aperture size, position, and shape of the perforations in the electrode plates. Similarly, the other conditions (other than the position of the perforations) may comprise the relative positions, the potentials applied to the electrode plates, the number and shape of the electrode plates, and the aperture size, number, and shape of the perforations in the electrode plates. Similarly, the other conditions (other than the shape of the perforations) may comprise the relative positions, the potentials applied to the electrode plates, the number and shape of the electrode plates, and the aperture size, number, and position of the perforations in the electrode plates.

In a specific embodiment, as shown in portions b and c of FIG. 2, the charged substances can be converged by disposing one perforation (or, one perforation among several perforations that is accessible) in each intermediate electrode plate, allowing for a single-point printing with electric field control. By having a plurality of (accessible) perforations in each intermediate electrode plate, the charged substances can be dispersed, enabling a multi-point synchronous printing with electric field control. Preferably, by adjusting the number of perforations, an array of perforations can be achieved for array printing. For instance, with two perforations, the particle beam will be dispersed into two. The number of the perforations can range from 1 to 10000000. In another specific embodiment, as shown in portion c of FIG. 2 and portion d of FIG. 3, the motion path of the charged substances can be adjusted by changing the positions of the perforations. For example, if the perforations are positioned outward, the motion path of the charged substances also extends outward. Both the single-point printing and the multi-point synchronous printing are possible.

Additionally, the shape of the particle beam can be adjusted by changing the shapes of the perforations. The shapes of the perforations can be circular, square, polygonal, etc.

In one embodiment, the environment of the electrode plates can be vacuum, liquid phase, or gas phase. Preferably, the device for controlling the spatial electric field for 3D printing is set in an atmospheric pressure chamber.

In one embodiment, the potentials of the electrode plates are in a range between −100 kV and 100 kV.

In one embodiment, the distance between the adjacent electrode plates ranges from 100 nm to 1 m, and the inclination angle between each two adjacent electrode plates ranges from 0° to 90°.

In one embodiment, to visualize the shape of the electric field lines, charged nanoparticles produced by plasma spark discharge are used as the charged substances, with a high-purity N₂ airflow of 2 L/min carrying the charged nanoparticles.

To better describe the present disclosed device, the following specific embodiments are provided for description.

### Embodiment 1: Device for Controlling Spatial Electric Field for 3D Printing

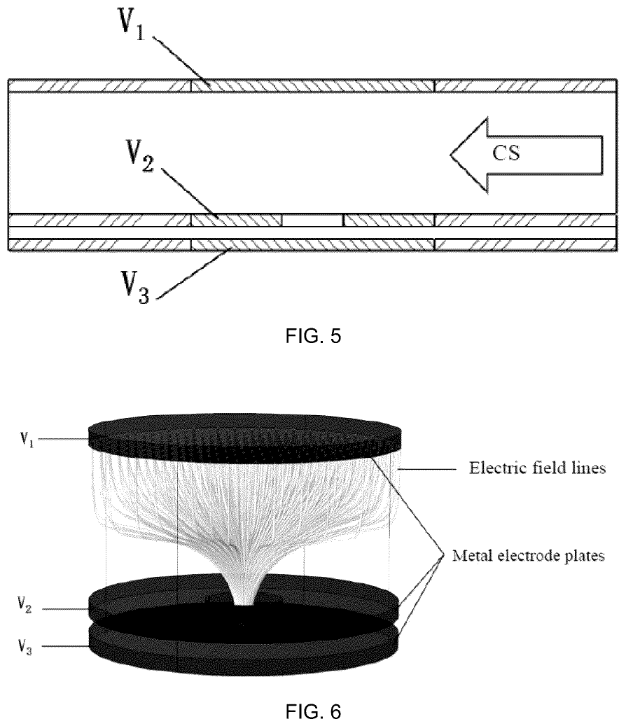

As shown in FIGS. 4 and 5, the main structure of the device comprises three circular metal electrode plates with identical outer contours. These three electrode plates are positioned on the same vertical centerline, and the surrounding environment is composed of insulating material to ensure that the calculation results of the spatial electric field match the actual situation. One of the electrode plates has a circular perforation, and the potentials from top to bottom are fixed at V₁, V₂, and V₃, respectively. Metal electrodes are embedded in an insulating cavity, with the entire cavity (from left to right) serving as the motion channel for charged substances. This device can create a funnel-shaped focusing electric field, with the spatial field lines shown in FIG. 6.

The top and bottom circular metal electrode plates have a diameter of 20 mm, while the intermediate metal electrode plate has an outer diameter of 20 mm and an inner diameter of 5 mm. The distance between the top electrode plate and the intermediate electrode plate is 10 mm, the distance between the intermediate electrode plate and the bottom electrode plate is 1 mm, and the thickness of the metal plates is 1 mm.

By adjusting the potentials of the three electrode plates, circular deposition spots of different diameters can be obtained on the bottom electrode plate. The results are shown in Table 1.

TABLE 1
Experimental Results of Controlling Shape of Single-Perforation Focused
Electric Field Lines Through Potentials of Three Electrode Plates

| | | | | | | | |
|---|---|---|---|---|---|---|---|
| Top Plate Voltage (V) | 0 | 0 | 0 | 0 | 0 | 0 | 0 |
| Intermediate Plate | 350 | 300 | 200 | 150 | 100 | 0 | −200 |
| Voltage (V) | | | | | | | |
| Bottom Plate Voltage (V) | −1450 | −1500 | −1600 | −1650 | −1700 | −1800 | −2000 |
| Hole Diameter (mm) | 5 | 5 | 5 | 5 | 5 | 5 | 5 |
| Spot Diameter (mm) | 0.58 | 0.64 | 0.84 | 1.24 | 1.32 | 1.65 | 1.96 |

| | | | | | | | |
|---|---|---|---|---|---|---|---|
| Top Plate Voltage (V) | 0 | 0 | 0 | 0 | 0 | 0 | 0 |
| Intermediate Plate | −400 | −800 | −1600 | −2400 | −3200 | −1600 | −2000 |
| Voltage (V) | | | | | | | |
| Bottom Plate Voltage (V) | −2200 | −2600 | −3400 | −4200 | −5000 | −2000 | −2000 |
| Hole Diameter (mm) | 5 | 5 | 5 | 5 | 5 | 5 | 5 |
| Spot Diameter (mm) | 1.89 | 2.11 | 2.41 | 2.61 | 2.72 | 3.3 | 5.2 |

By comparing the diameters of the deposition spots with the diameters of the perforations, it is clear that adjusting the electric field strength above and below the intermediate electrode plates using potentials can achieve different focusing effects. The focusing diameter ratio can reach up to 10 times, and the beam cross-section convergence can reach up to 100 times. Moreover, the focusing capability achieved by these potentials is not the limit. The width of the focused electric field lines obtained by this method theoretically has no lower limit.

### Embodiment 2: Device for Controlling Spatial Electric Field for Arrayed 3D Printing

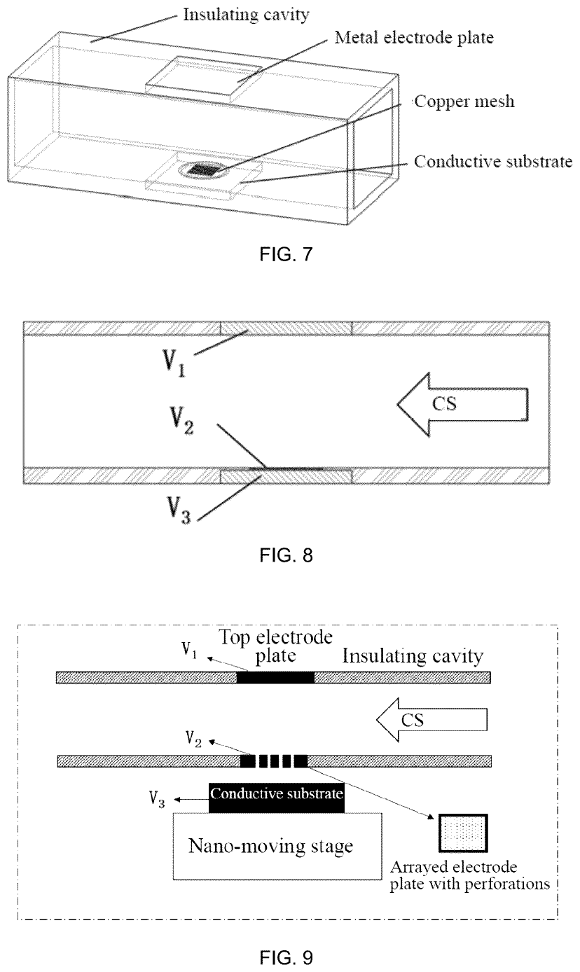

As shown in FIGS. 7 and 8, the main structure of the device comprises a metal electrode plate, a copper mesh, a conductive substrate, and an insulating cavity. The copper mesh has an array of circular perforation patterns. From top to bottom, the potentials of the metal electrode plate, copper mesh, and conductive substrate are fixed at V₁, V₂, and V₃, respectively. The left-right direction of the entire cavity serves as the motion channel for charged substances. This device can create a sieve-shaped focusing electric field.

The metal electrode plate and the conductive substrate used in Embodiment 2 measure 5 mm×5 mm with a thickness of 0.5 mm. The copper mesh has a thickness of 20 μm, a perforation diameter of 100 μm, and a perforation spacing of 150 μm, with the array of circular perforation patterns being 10×10. The vertical distance between the top metal electrode plate and the copper mesh is 5 mm, and the distance between the copper mesh and the conductive substrate can be 350 μm, 150 μm, or 50 μm.

By adjusting the potentials of the metal electrode plate, copper mesh, and conductive substrate, circular deposition spots of different diameters can be obtained on the conductive substrate. The results are shown in Table 2.

TABLE 2
Experimental Results of Controlling Shape of Perforation Array Focusing
Electric Field Lines Through Potentials of Three Electrode Plates

| | | | | | | | | |
|---|---|---|---|---|---|---|---|---|
| Top Plate Voltage (V) | 0 | 0 | 0 | 0 | 0 | 0 | 0 | 0 |
| Intermediate Plate Voltage (V) | 85 | 75 | 50 | 0 | −50 | −100 | −200 | −100 |
| Bottom Plate Voltage (V) | −615 | −625 | −650 | −700 | −600 | −600 | −1200 | −1100 |
| TEM Copper Mesh to | 150 | 150 | 150 | 150 | 50 | 50 | 350 | 350 |
| Substrate Distance (μm) | | | | | | | | |
| Array Hole Diameter (μm) | 100 | 100 | 100 | 100 | 100 | 100 | 100 | 100 |
| Array Point Distance (μm) | 7.7 | 13.7 | 14.45 | 20.7 | 27.72 | 29.96 | 60.47 | 41.84 |

| | | | | | | |
|---|---|---|---|---|---|---|
| Top Plate Voltage (V) | 0 | 0 | 0 | 0 | 0 | 0 |
| Intermediate Plate Voltage (V) | −100 | −650 | −1950 | −2600 | −650 | −1950 |
| Bottom Plate Voltage (V) | −600 | −1650 | −2950 | −3600 | −750 | −2250 |
| TEM Copper Mesh to | 350 | 350 | 350 | 350 | 350 | 350 |
| Substrate Distance (μm) | | | | | | |
| Array Hole Diameter (μm) | 100 | 100 | 100 | 100 | 100 | 100 |
| Array Point Distance (μm) | 67.46 | 69.3 | 72.4 | 77.43 | 117.4 | 109.3 |

By comparing the diameters of the arrayed deposition spots with the diameters of the arrayed perforations, it is clear that adjusting the electric field strength above and below the copper mesh, or altering the distance between the electrode plates with applied potentials, can achieve different focusing effects. The focusing diameter ratio can reach up to 12 times, and the beam cross-section convergence can reach up to 150 times. Moreover, the focusing capability achieved by these potentials as shown above is not the limit. The width of the focused electric field lines obtained by this method theoretically has no lower limit.

### Embodiment 3: Device for Controlling Spatial Electric Field for Micro-Nano Arrayed 3D Printing

As shown in FIG. 9, the main structure of the device comprises a nano-moving stage for loading and moving the conductive substrate to achieve 3D printing, and three metal electrode plates with fixed potentials. The potentials from top to bottom of the metal electrode plates are V₁, V₂, and V₃, respectively. The arrayed electrode plate comprises circular perforations with a diameter of 3 μm and a perforation spacing of either 10 μm or 15 μm. The height and width of the insulating cavity channel are both 5 mm.

The charged substances are charged nanoparticles produced by plasma spark discharge, with a high-purity N₂ airflow of 2 L/min carrying the charged nanoparticles.

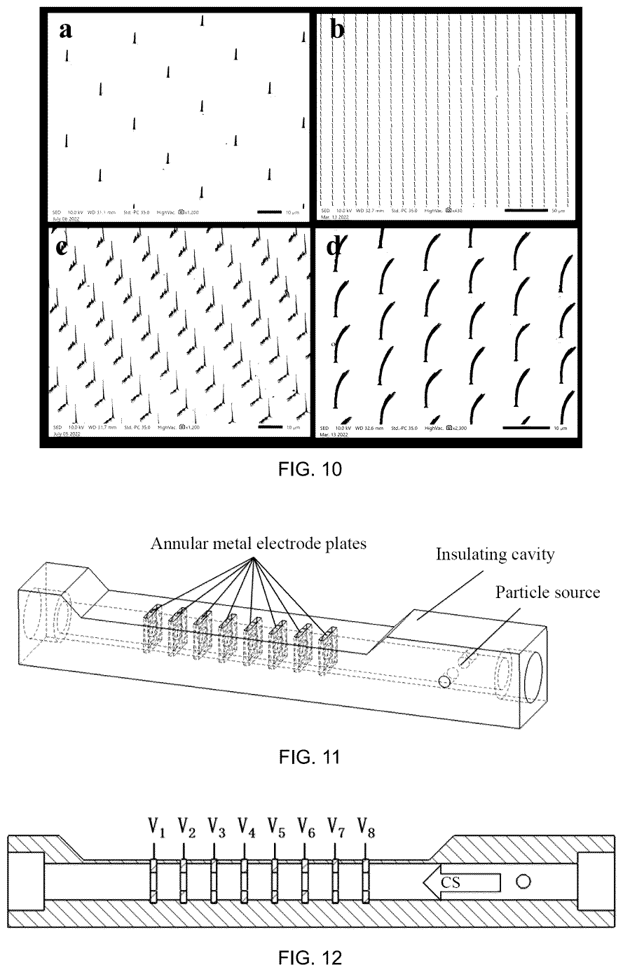

The arrayed micro-nano 3D structure shown in FIG. 10 was printed using the described device. The printing duration was approximately 1 hour, and the structure size was about 500 nm.

The above results indicate that the presently disclosed method is feasible at the nano-scale and can be applied to practical 3D printing designs.

### Embodiment 4: Particle Screening Device Using Multi-Plate Spatial Electric Fields

As shown in FIGS. 11 and 12, the main structure of the device comprises multiple annular metal electrode plates and an insulating cavity. The annular metal electrode plates are embedded within the insulating cavity, with a distance of 5 mm between each electrode plate. The outer diameter of each annular metal electrode plate is 7 mm, and the inner diameter is 3 mm. From right to left, the potentials of the electrode plates are fixed at V₁, V₂, V₃, V₄, V₅, V₆, V₇, and V₈, respectively. The entire cavity (from left to right) serves as the motion channel for charged substances, enabling the screening of charged particles passing through the channel.

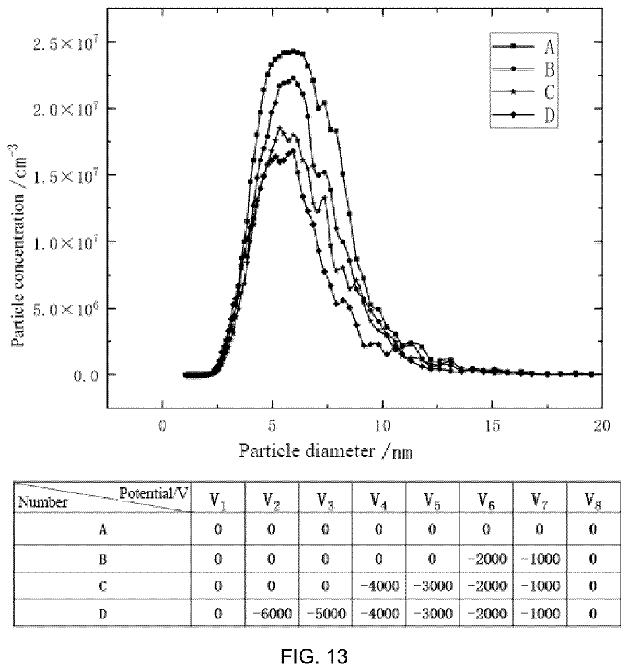

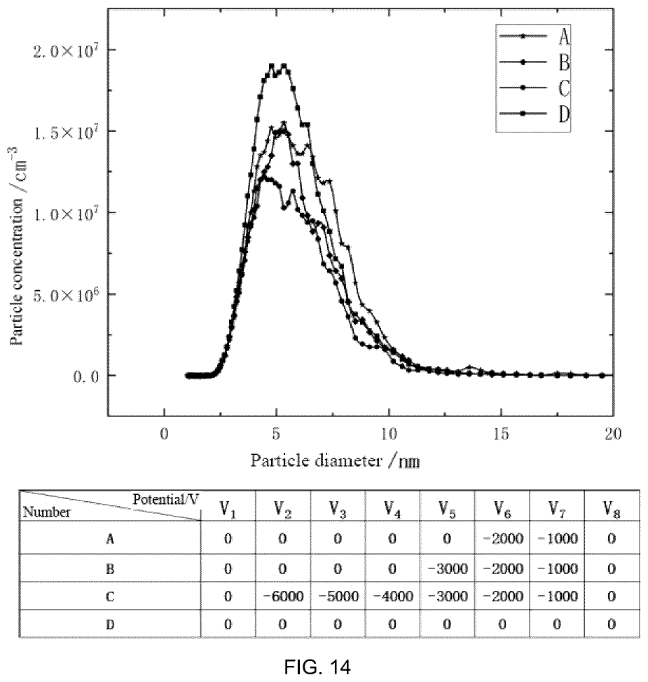

FIGS. 13 and 14 show the experimental results of particle size distribution adjustment achieved with the present disclosed device. Different spark parameters were used in FIGS. 13 and 14, resulting in initial charged nanoparticle sources with different size distributions. The particle size distributions of the charged particles were measured using a Scanning Mobility Particle Sizer (SMPS). It can be seen that the particle concentration significantly decreases after each additional stage of screening electric fields, indicating that part of single particles with specific electrical displacements were screened and filtered by the present disclosed device.

The above embodiments demonstrate that the focusing function of the present disclosed device can also achieve separation, dispersion, and/or blockage of charged substances without changing the overall structure. When the charged substances, with both positive and negative charges, simultaneously pass through the channel, this device can separate the positive and negative charges. Additionally, by reversing the electric field direction, this device can achieve the dispersion effect of originally focused charged substances. By injecting the charged substances from the bottom and intermediate electrode plates or releasing the charged substances from the focused electric field line position, the present disclosed device can achieve the ejection and dispersion of charged substances. Based on the same principle, the present disclosed device can easily block the charged substances with a single polarity. This method can be used for arrayed additive manufacturing of charged nanoparticles, signal enhancement and processing, charged particle or charge screening, and other applications.

In summary, for the present disclosed device, by sequentially arranging a top electrode plate, a configurable number of intermediate electrode plates with perforations, and a bottom electrode plate, and altering their configurable potential, relative position, and the size, number, shape, and distribution of perforations on the plates, a focused electric field required for printing is constructed. This focused electric field can then focus, disperse, screen, and separate the charged substances within it. Furthermore, by adjusting the potentials of the plates, plate positions, and the perforation distribution on the plates, the strength and the shape of electric field lines for the spatial electric field can be modified, enabling control over the feature sizes and printing locations of the 3D nanoarchitectures, offering high flexibility, simplicity, and strong controllability. In addition, the present disclosed device can be applied across various scales. Depending on the scale of the corresponding device, the present disclosed device can 3D print structures ranging from centimeters to nanometers. Moreover, the present disclosed device is versatile and can be utilized in fields such as micro-nano processing, separation engineering, and signal processing, thereby achieving functions like beam converging, signal modulation, dispersion, or screening. Therefore, the present disclosure effectively overcomes various shortcomings in the existing technology and has high industrial utilization value.

The above-mentioned embodiments are for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the scope of the present disclosure.

1. A device for controlling a spatial electric field for 3D printing, comprising:
a top electrode plate, a configurable number of intermediate electrode plates, and a bottom electrode plate disposed in sequence;
wherein each of the intermediate electrode plates is provided with a configurable number of perforations for electric field lines to pass through, so as to form motion channels of charged substances; wherein each of the top electrode plate, the intermediate electrode plates, and the bottom electrode plate has a configurable potential applied thereto;
wherein shapes of a particle beam formed by the charged substances are controlled by one or more of adjusting methods comprising adjusting relative positions of the intermediate electrode plates with respect to the top and bottom electrode plates, changing the potentials applied to the electrode plates, and varying positions of the perforations on the intermediate electrode plates, wherein the spatial electric field is constructed such that the charged substances migrate to a specific position on the bottom electrode plate, controlling feature sizes and printing locations of 3D nanoarchitectures.

2. The device according to claim 1, wherein one or more adjustments comprising a convergence state adjustment, a dispersion state adjustment, a screening state adjustment, a separation state adjustment, a signal strength change adjustment, and a motion path adjustment are performed on the charged substances by one or more of the adjusting methods.

3. The device according to claim 2, wherein a motion path of the charged substances is adjusted by adjusting the relative positions of the intermediate electrode plates with respect to the top and bottom electrode plates, wherein the relative positions comprise relative angular positions and distances between the electrode plates;
wherein a bending state of the particle beam is adjusted by adjusting the relative angular positions, and dimensions of the particle beam are adjusted by adjusting the distance between the electrode plates.

4. The device according to claim 2, wherein the shapes, direction, dimensions, and strength of the particle beam are adjusted by adjusting the potentials applied to the electrode plates, such that one or more of the adjusting methods are performed on the charged substances.

5. The device according to claim 4, wherein the potentials applied to the electrode plates are configured to toggle between different modes comprising: a first mode where a convergent electric field is formed to focus the charged substances; a second mode where a dispersing electric field is formed to disperse the charged substances; a third mode where a particle screening electric field is formed to screen the charged substances; a fourth mode where a separating electric field is formed to separate the charged substances; and a fifth mode where the charged substances generate a specific signal detectable by a corresponding sensor.

6. The device according to claim 1, wherein the charged substances comprise one or more of particles ranging from atomic to microns in size, or other particles like electrons, protons, and ions, and the charged substances are formed by metals, alloys, or semiconductors, or some insulating materials, each of which is charged.

7. The device according to claim 1, wherein a distribution of the spatial electric field is adjusted by adjusting the number and/or shape of the intermediate electrode plates, and the charged substances are controlled to move along the electric field lines having a preset shape.

8. The device according to claim 1, wherein dimensions and shapes of the particle beam are controlled by adjusting one or more of aperture sizes, the number of the perforations, the positions of the perforations, and shapes of the perforations on the intermediate electrode plates, so as to control a directional migration of the particle beam.

9. The device according to claim 8, wherein a single-point printing controlled by the spatial electric field is performed when each of the intermediate electrode plates is configured with one accessible perforation, and a multi-point synchronous printing controlled by the spatial electric field is performed when each of the intermediate electrode plates is configured with a plurality of accessible perforations.

10. The device according to claim 1, wherein dielectrics among the electrode plates are liquids or gases, or space among the electrode plates that is in a vacuum state.
